(19) United States
(12) Patent Application Publication
(10) Pub. No.: US 2015/0012322 A1
(43) Pub. Date: Jan. 8, 2015

(54) GENERATING COST OPTIMIZED SEQUENCES OF ACTIVITIES, FOR MULTIPLE VALUES OF A SEQUENCE ATTRIBUTE, FOR NUMEROUS TIME PERIODS OF A DAY

(71) Applicant: Oracle International Corporation, Redwood Shores, CA (US)

(72) Inventors: Nabil Guerinik, Boulogne-Billancourt (FR); Malika Guerinik, Boulogne-Billancourt (FR); Guillaume Beuchard, Nantes (FR)

(21) Appl. No.: 13/934,148

(22) Filed: Jul. 2, 2013

(51) Int. Cl. G06Q 10/10

(52) U.S. Cl. CPC G06Q 10/1097
USPC 705/7.21

(57) ABSTRACT

A computer and method generate a new sequence of assignments of activities of work (e.g. cleaning, sales, accounting) to be performed by an employee, in a particular time period in a day in an organization. An attribute of the new sequence (e.g. number of transitions between activity assignments) has a specific value that is then used to identify a stored sequence from a matrix. Then, costs of these two sequences are compared to determine one of the new sequence or the stored sequence to be an optimal sequence, for the specific value of the attribute and the particular time period. The optimal sequence is then stored in the matrix. In this manner multiple optimal sequences are obtained for several values of the attribute and for numerous time periods in the day. The optimal sequences may be combined with periods of breaks to form a daily schedule.

### CROSS REFERENCE TO RELATED APPLICATIONS

This application is related to U.S. application Ser. No. ______, Attorney Docket: ORA130130-US-NP-2, entitled “GENERATING MULTIPLE OPTIMAL DAILY SCHEDULES FOR MULTIPLE TIME PERIODS IN A DAY AND FOR MULTIPLE DAILY PATTERNS” filed concurrently herewith, by Nabil Guerinik et al. which is incorporated by reference herein in its entirety.

This application is also related to U.S. application Ser. No. 13/804,529 entitled “MODELING A GAP BETWEEN WORKLOAD AND NUMBER OF EMPLOYEES TO BE SCHEDULED BY CREATING AND USING NEW WORKLOAD LEVELS” filed on Mar. 14, 2013 by Nabil Guerinik et al. which is incorporated by reference herein in its entirety.

### BACKGROUND

It is common in today's businesses to automatically prepare schedules for employees to perform various activities to accomplish the work to be done in the businesses, as described in, for example, U.S. Pat. No. 6,823,315 entitled “Dynamic Workforce Scheduler” granted to Bucci et al. which is incorporated by reference herein in its entirety as background. U.S. Pat. No. 6,823,315 appears to describe a method of dynamically scheduling a workforce, which includes obtaining employee preferences, determining a workforce schedule, determining a schedule value, iteratively modifying the workforce schedule, determining a schedule value for the modified workforce schedule, and comparing schedule values to determine a best workforce schedule.

U.S. Pat. No. 7,725,339 entitled “Contact Center Scheduling Using Integer Programming” granted to Aykin is incorporated by reference herein in its entirety as background. This patent appears to describe a method for formulating a Mixed Integer Linear Programming (MILP) model, and a solution algorithm for developing optimal schedules. More specifically, U.S. Pat. No. 7,725,339 appears to describe obtaining a solution to satisfy constraints of a MILP model with a minimization (maximization) type objective function, such as total cost.

U.S. Pat. No. 6,278,978 entitled “Agent Scheduling System And Method Having Improved Post-Processing Step” granted to Andre et al. is incorporated by reference herein in its entirety as background. U.S. Pat. No. 6,278,978 appears to state that evaluation of a score function for a possible schedule includes selecting, for each interval in the possible schedule, one of multiple predetermined values corresponding to distinct staffing levels. U.S. Pat. No. 6,278,978 appears to use a post-processing procedure for optimizing a schedule. However, use of a post-processing procedure can have drawbacks, e.g. a large number of iterations may be needed to obtain a locally optimal schedule. When a maximum number of iterations is reached, the post-processing must be terminated, etc. Hence, there is a need for an improvement of the type described below.

### SUMMARY

In several aspects of described embodiments, a method and one or more computer(s) automatically generate a new sequence of assignments of activities of work (e.g. cleaning, sales, accounting) to be performed by an employee in a particular period of time in a day in an organization (e.g. a store). An attribute of the new sequence (e.g. number of transitions between activity assignments) has a specific value that is then used to identify a stored sequence (e.g. from a matrix). Then, an optimal sequence of activity assignments having the specific value of the sequence attribute is determined to be one of the new sequence or the stored sequence, based on comparison of costs of these two sequences. The optimal sequence is then stored in the matrix (e.g. when a new sequence is determined to be more optimal than the stored sequence, the stored sequence in the matrix is replaced by the new sequence). In this manner multiple optimal sequences are obtained and stored in the matrix, for multiple values (A values, e.g. 5 values) of the sequence attribute, and for numerous time periods (N periods, e.g. 96 periods) in the day. Finally, the matrix may be used to form multiple schedules as combinations of optimal sequences and periods of breaks, from which one combination is selected as a day schedule for the employee. The above-described process may be repeated, for other days in a week (or month), and for other employees in the organization.

Replacement of a stored sequence in the matrix by a new sequence reduces computation and memory. Specifically, overwriting a stored sequence which is less optimal than a new sequence reduces memory otherwise needed to continue to store the stored sequence. Moreover, such overwriting also eliminates computation otherwise incurred if the stored sequence (which is less optimal than a new sequence) continued to be stored and used in comparisons with other sequences.

It is to be understood that several other aspects and embodiments will become readily apparent to those skilled in the art from the description herein, wherein it is shown and described various aspects by way of illustration. The drawings and detailed description below are to be regarded as illustrative in nature and not as restrictive.

### BRIEF DESCRIPTION OF THE DRAWINGS

FIG. 1A illustrates, in a high-level block diagram, an optimal sequence populator 110 of several embodiments that automatically maintains in a matrix 1501 in memory 1106, optimal sequences of assignments of work activities for each employee I in an organization for corresponding values of an attribute of a sequence, and for multiple periods of time (e.g. different starting time slots and/or different ending time slots) in a day.

FIG. 1B illustrates, in a high-level flow chart, acts performed by computer 1000 in several embodiments, to use the sequence's attribute, to maintain the optimal sequences in matrix 1501 (FIG. 1A).

FIG. 2A illustrates, in a table, a sequence of arcs 151A, 153B and 152C formed by computer 1000 to represent three respective activities to be scheduled between 8:00 am and 9:30 am with transitions between activities occurring at 8:30 am and 9:00 am.

FIG. 2B illustrates, in a graph, arcs 151A, 153B and 152C in the sequence of FIG. 2A to be scheduled in the specific period of time 154 between 8:00 am and 9:30 am.

FIG. 2C illustrates, in another table, another sequence of arcs 153A, 151B and 152C formed by computer 1000 to represent three respective activities to be scheduled between 8:00 am and 9:30 am, also with transitions between activities occurring at 8:30 am and 9:00 am.

FIG. 2D illustrates, in a graph, arcs 153A, 151B and 152C in the sequence of FIG. 2C to be scheduled in the specific period of time 154 between 8:00 am and 9:30 am.

FIG. 2E illustrates, in another table, another sequence of arcs 153A, 151B and 153C formed by computer 1000 to represent three respective activities to be scheduled between 8:00 am and 9:30 am, also with transitions between activities occurring at 8:30 am and 9:00 am.

FIG. 2F illustrates, in a graph, arcs 153A, 151B and 153C in the sequence of FIG. 2E to be scheduled in the specific period of time 154 between 8:00 am and 9:30 am.

FIGS. 3A-3F illustrate, in tables, sequences formed by computer 1000 to represent two activities to be scheduled in the specific period of time 154 between 8:00 am and 9:30 am, with a single transition at 8:30 am.

FIG. 3G illustrates, in a graph, the sequences of FIGS. 3A-3F.

FIGS. 4A-4F illustrate, in tables, sequences formed by computer 1000 to represent two activities to be scheduled in the specific period of time 154 between 8:00 am and 9:30 am, with a single transition at 8:45 am.

FIG. 4G illustrates, in a graph, the sequences of FIGS. 4A-4F.

FIG. 5A illustrates, in a graph, sequences formed by computer 1000 to represent a single activity to be scheduled in the specific period of time 154 between 8:00 am and 9:30 am, with no transition.

FIG. 5B illustrates, in another graph, sequences formed by computer 1000 to represent activities to be scheduled in different periods of time during a day.

FIG. 6 illustrates, in an intermediate-level flow chart, acts performed by a computer 1000 in several embodiments, to select a sequence from among multiple sequences for a specific time period.

FIGS. 7A and 7B illustrate, in block diagrams, hardware and software portions of a computer 1000 that performs the method illustrated in FIGS. 1B and 6.

### DETAILED DESCRIPTION

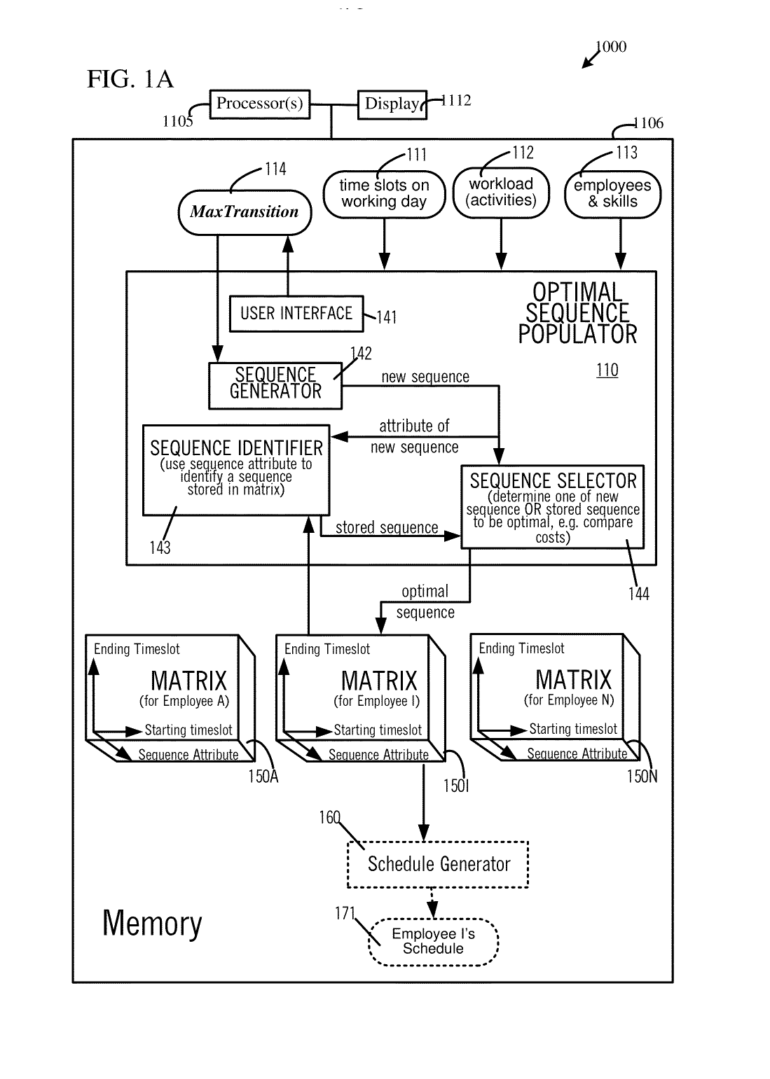

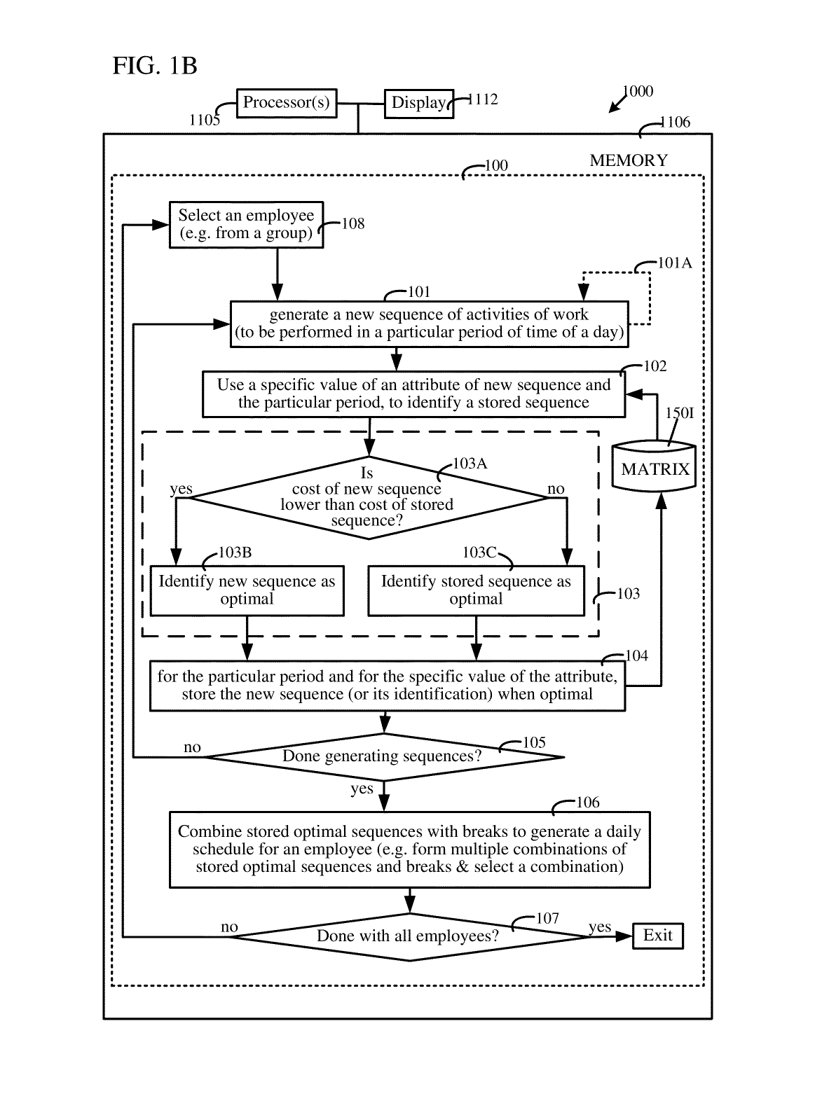

In several aspects of described embodiments, a computer 1000 (FIG. 1A) is programmed with software in a memory 1106 that when executed by one or more processor(s) 1105 performs a set of acts 101-106 in a method 100 (FIG. 1B) to populate in a matrix 1501, sequences in time of assignments of one or more activities of work to be performed by an employee I in an organization. Specifically, computer 1000 of some embodiments includes an optimal sequence populator 110 that in turn includes a user interface 141, a sequences generator 142, a sequence identifier 143 that is attribute specific, and a sequence selector 144 that is cost based.

Before performing act 101 in the set of acts 101-106, some embodiments of optimal sequence populator 110 in computer 1000 may select an employee I in an act 108 from among multiple employees A . . . I . . . N in a group of employees in the organization. On completion of act 106, optimal sequence populator 110 in computer 1000 checks in an act 107, whether a matrix of optimal sequences has been generated for each employee in the group of employees (e.g. who work at a specific geographic location) in the organization, and if not returns to act 108. In this manner, the set of acts 101-106 are performed by optimal sequence populator 110 for another employee A to generate their own matrix 150A, and also performed for still another employee N to generate their matrix 150N.

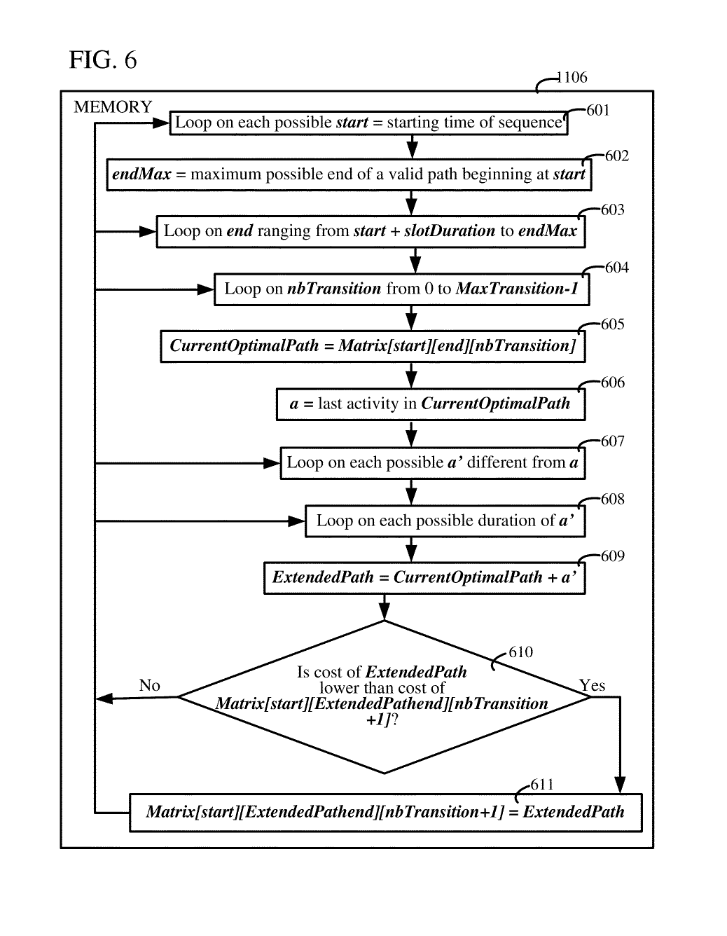

Although a loop has been shown in FIG. 1B, from act 107 to 108 so that acts 101-106 may be performed by a single process in a single processor in computer 1000 to implement optimal sequence populator 110, in other embodiments the loop may be unrolled and the set of acts 101-106 may be performed by different processes in the single processor or by different processors in computer 1000. Moreover, although loop unrolling has just been described for a single loop between acts 107 and 108 of optimal sequence populator 110, such loop unrolling may be done for other loops illustrated in FIG. 1B (or illustrated in FIG. 6, which is described below).

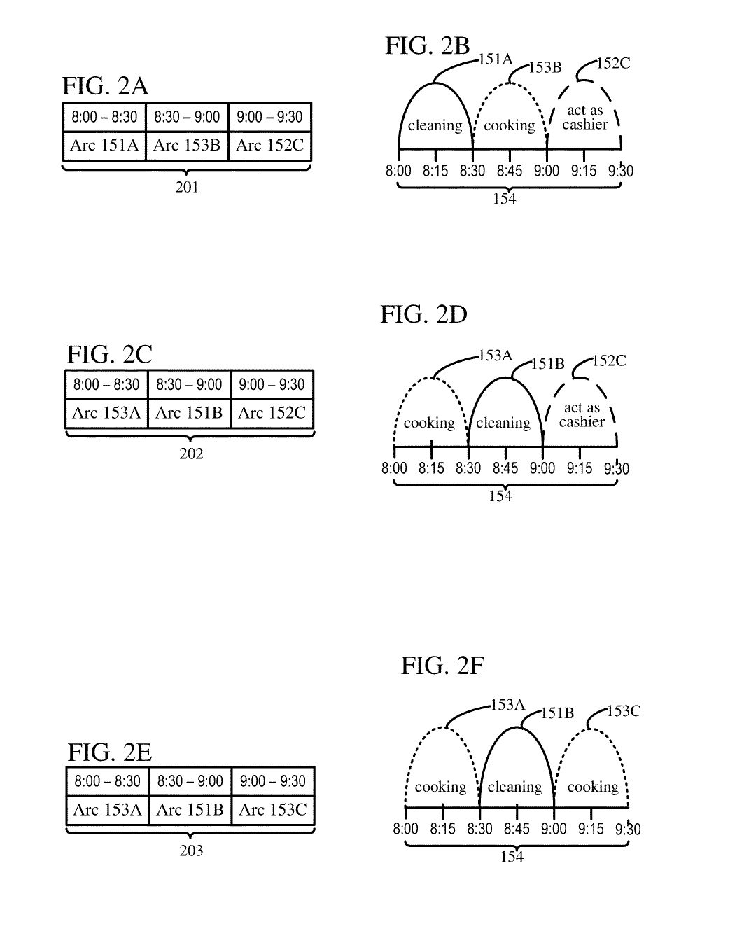

Sequences generator 142 (FIG. 1A) when operated (e.g. by processor(s) 1105 executing instructions in memory 1106) performs an act 101 (FIG. 1B) whereby computer 1000 generates one or more sequence(s) of assignments of activities of work to be performed by an employee in the organization, in a specific time period (also called specific time interval) in a day. Thus in several embodiments of optimal sequence populator 110, sequence generator 142 constitutes means for generating one or more sequences (e.g. sequence 201 in FIG. 2A, sequence 202 in FIG. 2C and sequence 203 in FIG. 2E) of activities of work scheduled for performance, in a group of time slots (e.g. of 15 minute duration) in a specific period of time (e.g. period of time 154). Depending on the embodiment, one or more such sequences of assignment(s) of one or more work activities may be stored in memory 1106, e.g. in a matrix 1501 (FIG. 1A) for a given employee I.

In an illustrative example shown in FIG. 2A, sequence generator 142 in computer 1000 performs act 101 of FIG. 1B to generate for employee I, a new sequence 201 of work activities to be performed in a bakery store, which is represented by an initial assignment (see arc 151A in FIGS. 2A and 2B) of an activity of cleaning, to be scheduled in the first two time slots of 15 minutes duration in a day between the times 8:00 am and 8:30 am, followed by an intermediate assignment (see arc 153B in FIGS. 2A and 2B) of another activity of cooking to be scheduled in the next two time slots between the times 8:30 am and 9:00 am, followed by a final assignment (see arc 152C in FIGS. 2A and 2B) of still another activity performed by a cashier (e.g. at a cash register) to be scheduled between the times 9:00 am and 9:30 am. In such embodiments, new sequence 201 is formed to not include any time period of break (e.g. for rest, for lunch etc). Hence, each activity assigned in sequence 201 to a specific period of time is an activity of work to be done (e.g. in the bakery store). Thus, sequence 201 is an uninterrupted sequence of one or more work activities, to be performed by employee I during the half-an-hour time period between the times 8:00 am and 8:30 am.

In the above-described example, although three specific assignments of work activities to six time slots between the times 8:00 am and 9:30 am in the specific period of time 154 in a day (denoted by initial arc 151A, followed by intermediate arc 153B, followed by final arc 152C) are included in sequence 201, one or more such work activities of cleaning, cooking and cashier may be assigned differently, to generate several such sequences of work activities to be performed by the employee. In this example, new sequence 201 is a generated specifically for a given employee I during the one-and-half hour time period between the times 8:00 am and 9:30 am. Hence, in forming sequence 201, act 101 may use information specific to the given employee, such as the given employee's starting time, which is a time of day (e.g. 8:00 am) at which the given employee begins their work in the organization by physical coming to the organization's premises (and different employees may have different starting times). Depending on the embodiment, act 101 may be implemented in some embodiments to satisfy one or more predetermined constraints in selecting work activities to be assigned when generating a sequence for an employee, such as employee's skills, employee's preferences, union rules on maximum duration of a work sequence, and/or duration between shifts.

Thus, sequences generator 142 in computer 1000 of certain embodiments may repeatedly perform act 101 for a given employee I as shown by branch 101A (see FIG. 1B), for example to assign the same three work activities to other time slots in the same period of time 154 to generate additional new sequences. In one illustrative example, act 101 may be performed by sequences generator 142 a second time (either before or after generation of sequence 201 as described above), to generate one or more alternative sequences for the specific period of time 154, such as sequence 202 shown in FIG. 2C. Sequence 202 is represented by an initial arc 153A to denote cooking between 8:00 am and 8:30 am followed by intermediate arc 151B to denote cleaning between 8:30 am and 9:00 am followed by final arc 152C to denote acting as cashier between 9:00 am and 9:30 am, as shown in a table in FIG. 2C (and in a graph in FIG. 2D).

In act 101 of some embodiments, sequence generator 142 in computer 1000 may repeat assigning an activity of work to additional time slots later in a sequence after that work activity is already assigned to time slots earlier in the sequence, when there are one or more intermediate assignments there-between of other work activities. For example, computer 1000 may generate another alternative sequence 203 which is represented by an initial arc 153A to denote cooking between 8:00 am and 8:30 am, followed by intermediate arc 151B to denote cleaning between 8:30 am and 9:00 am, followed by final arc 153C to denote cooking again between 9:00 am and 9:30 am (i.e. repeat assigning the cooking activity), as shown in a table in FIG. 2E (and in a graph in FIG. 2F). So, activities of work that an employee can perform during a day in an organization are used by computer 1000 of some embodiments to form numerous sequences as described herein, e.g. by permutation.

Optimal sequence populator 110 in computer 1000 of some embodiments includes a sequence identifier 143 designed to perform an act 102 (FIG. 1B) to automatically use a value of an attribute of a sequence (that is newly generated by sequence generator 142) to identify a previously-generated sequence (also called “stored” sequence), for the same period of time. Thus, a newly-generated (or new) sequence 201 and a previously-generated (or stored) sequence 202 both for the period of time 154, and both having the same value of a sequence attribute may be compared (by sequence selector 144 in act 103A) as alternatives to one another, followed by storage in a matrix 150 (FIG. 1B) of whichever one of these two sequences is determined (by sequence selector 144) to be more optimal (e.g. whichever of the two sequences is determined to cost less).

An attribute of a sequence (also called sequence attribute), which is used by sequence identifier 143 in act 102 has a value determined by assignments of activities that are included in the sequence. In some embodiments, the attribute used in act 102 is the number of transitions between assignments in the sequence. In the example illustrated in FIG. 2A, sequence 201 has two transitions, wherein one transition occurs at 8:30 am and another transition occurs at 9:00 am. In the example illustrated in FIG. 2C, sequence 202 has two transitions. Accordingly, in act 102, sequence identifier 143 may use the value 2 which is the number of transitions of sequence 201 (assuming newly generated by sequence generator 142) to automatically identify sequence 202 (assuming previously generated and stored in matrix 150). Thus, sequence identifier 143 of some embodiments constitutes means responsive to the value of an attribute of a newly-generated sequence, for identifying a previously-generated sequence (which includes its own assignments of the activities).

Note that the number of transitions in a sequence is always one less than a number of assignments of activities, which is another attribute of the sequence. In the example illustrated in FIG. 2A, sequence 201 has three assignments, which is one less than the value 2 (which is the number of transitions, as noted above). Thus, the sequence attribute used by sequence identifier 143 in act 102 of some embodiments may be the number of assignments (instead of the number of transitions). Thus, in act 102 of such embodiments, sequence identifier 143 may use the value of 3 as the number of assignments in sequence 201 to automatically identify sequence 202 (as having the same number of assignments), for input to sequence selector 144.

In performing act 102, certain embodiments may use other attributes of a sequence in sequence identifier 143, such as the number of activities. In the example illustrated in FIG. 2A, each of sequences 201 and 202 has three activities (namely, cleaning, cooking and cashier), so sequence identifier 143 may use the value of 3 as the number of activities of a newly-generated sequence 201 to automatically identify a previously-generated sequence 202 for input to sequence selector 144. Note that sequence 203 has only two activities (namely cleaning and cooking, because the activity of cooking is repeated in this sequence), and hence the attribute value of sequence 203 is 2 which is therefore not eligible for comparison with sequence 201 (in a sub-optimal solution).

Sequence selector 144 (FIG. 1A) in some embodiments of computer 1000 is designed to perform an act 103 (FIG. 1B) to automatically select one of two sequences, for the specific period of time, and for a specific value of the sequence attribute. Specifically, in an act 103A, sequence selector 144 checks whether a cost of the newly-generated sequence (also called “new sequence”) is lower than another cost of the previously-generated sequence (also called “stored sequence”), and if yes then performs act 103B else performs act 103C. Hence, acts 103A, 103B and 103C are included in act 103 of some embodiments. The just-described cost of each sequence is retrieved by computer 1000 from memory 1106 (and the cost is stored therein after its computation, e.g. by adding up costs of individual activities included in the sequence).

Sequence selector 144 (FIG. 1A) in some embodiments of computer 1000 determines the cost of each sequence as the sum of the costs of each activity assigned therein. For example, the cost of sequence 201 may be computed by sequence selector 144 in act 103A by adding up three costs as follows: cost of cleaning between 8:00 am and 8:30 am, cost of cooking between 8:30 am and 9:00 am, and cost of acting as cashier between 9:00 am and 9:30 am. The cost of a previously-generated sequence 202 is stored in memory 1106 of some embodiments in association with the previously-generated sequence 202, and thus the cost of the sequence is retrieved from memory and supplied by sequence identifier 143 to sequence selector 144 with the sequence itself.

The costs of activities assigned to specific time slots may be computed by computer 1000 in any manner that may be apparent to the skilled artisan in view of this detailed description. In some illustrative embodiments, costs are computed for assignments of activities of work as described in, for example, U.S. application Ser. No. 13/804,529 entitled “MODELING A GAP BETWEEN WORKLOAD AND NUMBER OF EMPLOYEES TO BE SCHEDULED BY CREATING AND USING NEW WORKLOAD LEVELS” filed on Mar. 14, 2013 by Nabil Guerinik et al. which is incorporated by reference herein in its entirety. In several embodiments, computation cost is performed by a method of polynomial complexity. As time required to determine an optimal sequence in each cell of matrix 1501 is also polynomial, overall computation time to prepare matrix 1501 for an employee I scales in a linear manner relative to a number n of cells in the matrix i.e. O(n).

In act 103B, sequence selector 144 in computer 1000 identifies the newly-generated sequence as an optimal sequence for the specific period of time and for the value of the sequence attribute. In act 103C, sequence selector 144 identifies the previously-generated sequence as an optimal sequence for the specific period of time and for the value of the sequence attribute. In the above-described example, a cost of newly-generated sequence 201 is compared to a cost of previously-generated sequence 202 by sequence selector 144 in act 103A, and then one of the sequences 201 or 202 is identified as optimal, and the optimal sequence is stored by computer 1000, in act 104.

Comparison of the cost of two sequences as described above is performed in some embodiments by a digital comparator in an arithmetic logic unit (ALU) in a central processing unit (CPU) of a processor in a computer. Thus, means for comparing of some embodiments are implemented by one or more structures similar or identical to a binary comparator, such as TTL 7485 from Texas Instruments, or 74HC/HCT85 from Philips Semiconductors. Accordingly, a circuit to implement “means for comparing” the costs of two sequences will be apparent to a skilled artisan, in view of this description.

In act 104 (FIG. 1B), sequence selector 144 in computer 1000 stores in matrix 1501 for an employee I, either the optimal sequence or an identification thereof, depending on the embodiment. Specifically, in certain embodiments each cell in matrix stores a sequence of assignments of activities, whereas in other embodiments each cell in matrix 1501 stores a pointer to a location in memory 1106 at which is stored the sequence of assignments of activities, e.g. in a linked list or an array. Matrix 1501 of several embodiments contains an optimal sequence, for each employee I, for each period of time in a day, and for each value of the sequence attribute within a predetermined range. Such a predetermined range of values (e.g. A values) of a sequence attribute may be specified via a user interface 141, e.g. as a maximum number of transitions, MaxTransition 114 (see FIG. 1A).

Matrix 1501 of some embodiments may be looked up by sequence identifier 143 in computer 1000 using the value of the attribute as one index (also called “first” index). In several such embodiments, matrix 1501 is a three dimensional matrix with the just-described attribute value as the first index, a starting time of the specific period of time in a day as a second index and an ending time of the specific period of time as a third index. In alternative embodiments, matrix 1501 is a three dimensional matrix with the attribute value as the first index, a starting time of the specific period of time in a day as a second index and a duration of the specific period of time as a third index. In still other embodiments, matrix 1501 may be a two dimensional matrix with the attribute value as the first index, and a unique identifier of a specific period of time in a day as a second index.

Referring to FIG. 1B, in act 104 computer 1000 stores the new sequence in matrix 1501 when the new sequence is identified as optimal (e.g. by act 103B). When an existing sequence is identified as optimal (e.g. by act 103C), no change needs to be made to matrix 1501. After completion of act 104, computer 1000 of some embodiments goes to act 105 to check if a condition for generating sequences is met, e.g. whether computer 1000 is done generating sequences. If the answer in act 105 is no, then computer 1000 returns to act 101 (described above), and generates another sequence of activities. As will be readily apparent in view of this detailed description, several alternative sequences can be generated for a specific period of time 154 (FIG. 2B), i.e. between 8:00 am and 9:30 am, e.g. sequences with transitions at different times, and/or sequences with fewer transitions (and therefore fewer assignments) and/or sequences with more transitions (and therefore more assignments).

In some embodiments, in performing act 101, computer 1000 is programmed to satisfy one or more additional constraints. For example, a constraint in an illustrative embodiment of computer 1000 ensures that each assignment of an activity is for at least two time slots, and for this reason an earliest transition in a sequence (for a day that starts at 8:00 am) can occur only at 8:30 am. Several sequences for the above-described time period 154 which may be generated by computer 1000 are described next.

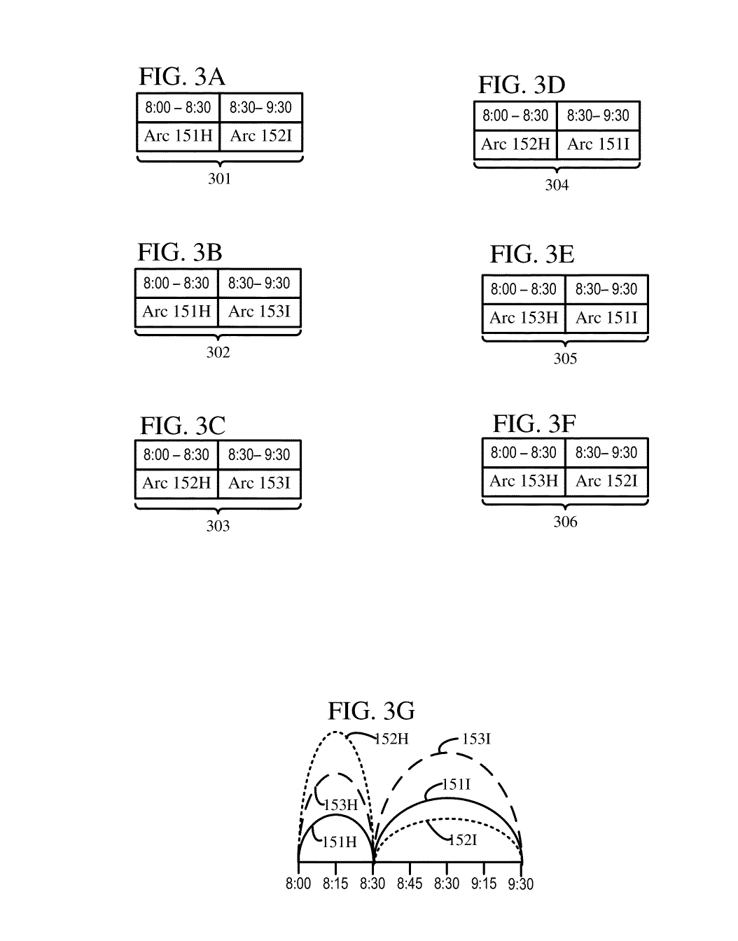

In one illustrative embodiment, on repeated performance of act 101, computer 1000 may generate the following six sequences (in any order relative to one another, and also in any order relative to sequences 201-203 described above): sequence 301 denoted by arc 151H followed by act 1521 (see FIG. 3A), sequence 302 denoted by arc 151H followed by act 1531 (see FIG. 3B), sequence 303 denoted by arc 152H followed by act 1531 (see FIG. 3C), sequence 304 denoted by arc 152H followed by act 1511 (see FIG. 3D), sequence 305 denoted by arc 153H followed by act 1511 (see FIG. 3E) and sequence 306 denoted by arc 153H followed by act 1521 (see FIG. 3F). Each of the just-described six sequences 301-306 (FIG. 3A-3F) has a single transition that occurs at 8:30 am, as illustrated in FIG. 3G.

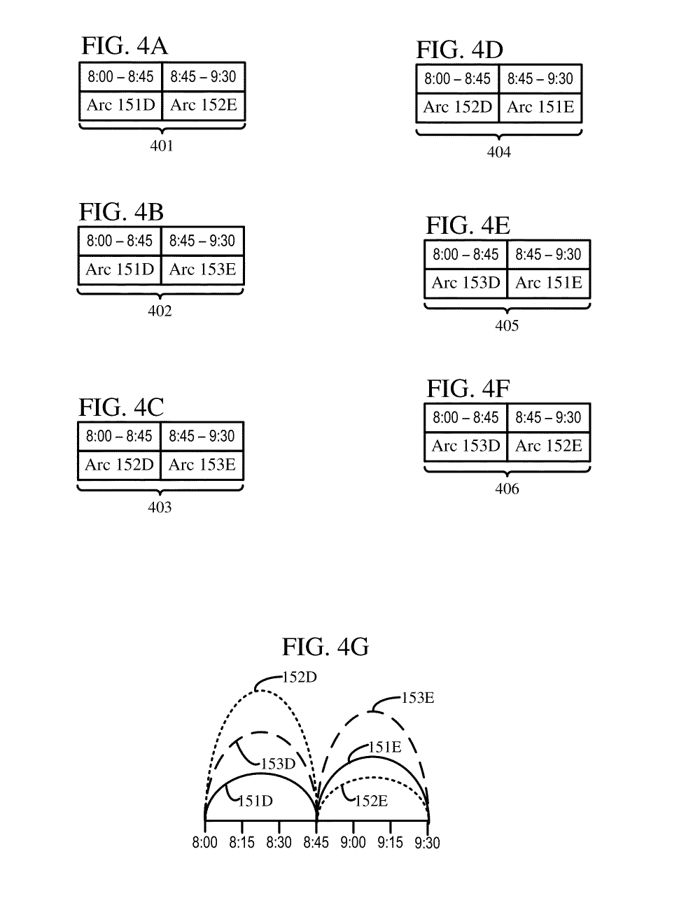

Similarly, on repeated performance of act 101, computer 1000 may additionally generate other sequences with a single transition at other times, e.g. at 8:45 am (FIG. 4G) as follows: sequence 401 denoted by arc 151D followed by act 152E (see FIG. 4A), sequence 402 denoted by arc 151D followed by act 153E (see FIG. 4B), sequence 403 denoted by arc 152D followed by act 153E (see FIG. 4C), sequence 404 denoted by arc 152D followed by act 151E (see FIG. 4D), sequence 405 denoted by arc 153D followed by act 151E (see FIG. 4E) and sequence 406 denoted by arc 153D followed by act 152E (see FIG. 4F).

Also, on repeated performance of act 101, computer 1000 may generate additional sets of sequences all of which have a single transition at 9:00 am (not shown). Regardless of how many sequences are generated for a specific period of time 154, in some embodiments only one sequence is stored in matrix 1501 for a specific value of the attribute. In the examples illustrated in FIGS. 3A-3F and 4A-4F, all of sequences 301-306 and 401-406 have a single value of the sequence attribute, e.g. just 1 transition, and hence matrix 1501 has a single cell to hold an identifier (e.g. a pointer to a memory location) of only one of these single-transition sequences (for the specific period of time 154).

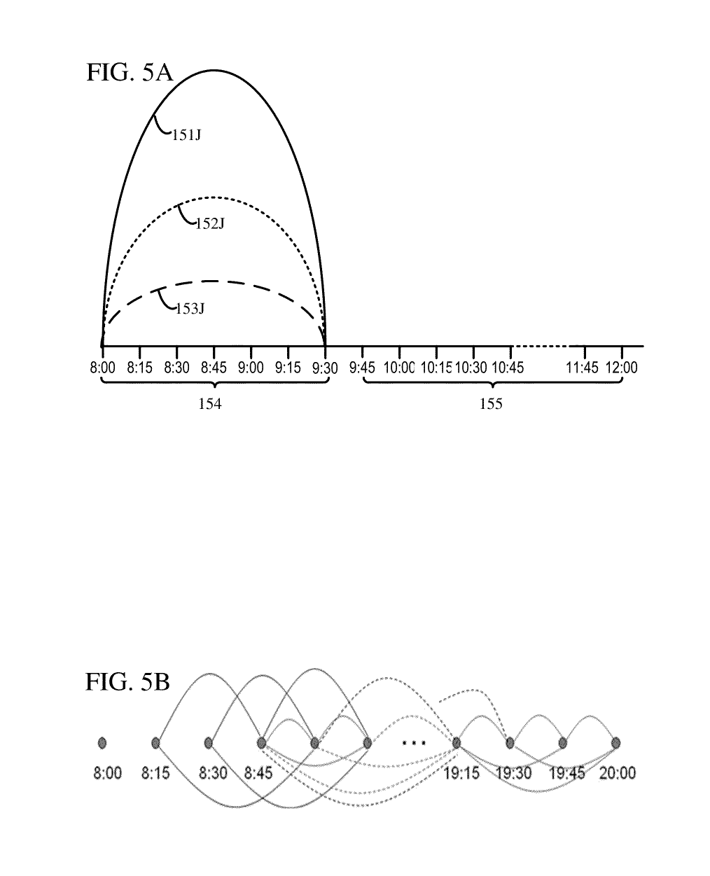

Computer 1000 of some embodiments may also generate in act 101 sequences that have no transitions, e.g. one sequence may have a single assignment of cleaning between 8:00 am and 9:30 am, as illustrated by arc 151J in FIG. 5A, another sequence may have a single assignment of cooking also between 8:00 am and 9:30 am as illustrated by arc 152J in FIG. 5A, and still another sequence may have a single assignment of acting as cashier also between 8:00 am and 9:30 am as illustrated by arc 153J in FIG. 5A.

Computer 1000 of such embodiments may additionally generate in act 101 (FIG. 1B) similar sequences for other time periods of a day wherein work is to be done continuously. In an illustrative example, another time period 155 (FIG. 5A) may be separated from the above-described time period 154 by a break period (e.g. of one or more time slots). In this example, computer 1000 generates sequences for time period 155 in a manner similar to that described above for the time period 154.

In some embodiments, computer 1000 is programmed to generate new sequences in act 101 by concatenating a new assignment of an activity of work to a last work activity assignment in a stored sequence. When a stored sequence is null, its last activity is also null, and in this situation a new activity assignment is itself used as the new sequence in act 101. Similarly, in comparing a new sequence with a stored sequence in act 103A to determine cost optimality therebetween, when the stored sequence happens to be null, the new sequence is determined to be optimal and hence the new sequence is stored in matrix 1501, by performing act 103C.

Although a time period 154 has been described above as starting at a specific time slot, e.g. at 8:00 am, computer 1000 of some embodiments may be programmed to generate in act 101 sequences for time periods that are not separated from one another, and that may have different durations. For example, as illustrated in FIG. 5B, computer 1000 may generate such sequences for one time period starting at 8:15 am, and another time period starting at 8:30 am and yet another time period starting at 8:45 am. Similarly, time periods used by computer 1000 in generating sequences in act 101 may end at various time slots, e.g. end at 19:45 or end at 20:00.

Referring to FIG. 1B, when the answer in act 105 is yes, computer 1000 has completed populating matrix 1501 with optimal sequences for each valid value of the sequence attribute (among A values), and for each valid time period and so computer 1000 goes to act 106. In act 106, computer 1000 combines two or more of the stored sequences in matrix 1501 (each of which is an optimal sequence for a specific employee) with periods of time for breaks in which no activity of work is to be performed, e.g. time for the employee to eat lunch, or time for the employee to rest. Act 106 may be implemented in some embodiments depending on one or more constraints, such as employee I's preferences on when to start work, end work, etc. as well as union rules and/or governmental regulations on duration of time between breaks and/or duration of time between shifts.

Thus, in act 106, computer 1000 forms multiple alternative combinations (with each combination including a period of break between two optimal sequences of work activities selected from matrix 1501), followed by selecting a single combination from among the multiple alternative combinations, to be employee I's schedule for a day J. The specific manner in which act 106 is implemented to generate a complete schedule for a day J in a week (e.g. Monday), by selection of a single combination of sequences of work activities and break periods, can be different in different embodiments. The day schedule generated by act 106 is stored in memory 1106, e.g. as a portion of an employee I's weekly schedule 171 (FIG. 1A) that is accessible via user interface 141, and which may be used by employee Ito perform his/her work in the organization.

In some embodiments of act 106, two or more sequences in matrix 1501 (FIG. 1A) are used as two or more items of type work, which are interleaved with items of type break, based on a pattern of such items specified by an employee, to generate a schedule for a day for that employee, as described in detail in U.S. application Ser. No. ______, Attorney Docket: ORA130130-US-NP-2, entitled “GENERATING MULTIPLE OPTIMAL DAILY SCHEDULES FOR MULTIPLE TIME PERIODS IN A DAY AND FOR MULTIPLE DAILY PATTERNS” filed concurrently herewith, by Nabil Guerinik et al. which is incorporated by reference herein in its entirety.

Although in the above description, two-transition sequences are described initially in reference to FIGS. 2A-2F, followed by description of one-transition sequences in reference to FIGS. 3A-3F and 4A-4F, followed by description of zero-transition sequences in reference to FIG. 5A, such sequences may be generated by computer 1000 in act 101 (FIG. 1B) in any order relative to one another. In some embodiments, such sequences are generated in the opposite order relative to their description above, specifically with zero-transition sequences being generated initially, followed by generation of one-transition sequences, followed by generation of two-transition sequences, etc.

In some embodiments of the type described below in reference to FIG. 6, a new sequence is generated by sequence generator 142 adding a new assignment of an activity to the end of a last activity in an existing sequence. The existing sequence may be previously generated by sequence generator 142, and stored in memory 1106 (e.g. in matrix 1501). Initially, when there is no existing sequence, any activity may be used by sequence generator 142 to form a zero-transition new sequence of any duration that is valid (which is the specific time period).

In some embodiments, computer 1000 is programmed with instructions in memory 1106 to perform acts 601-611 (illustrated in FIG. 6) for each employee I, as follows. Specifically, in act 601, computer 1000 enters a first loop, for each possible value of a variable start which is set to the starting time of a sequence. Note that in the following description, the term “path” has the same meaning as the term “sequence” (described above). In one example, there are N=96 time slots in a day, with each time slot being of 15 minutes duration, and so the maximum value of variable start is N=96. Depending on the embodiment, other criteria, such as hours of business (e.g. 8:00 am to 6:00 pm) of an organization may be used in act 601, to select a valid value for the variable start. Additionally, an employee's schedule for the previous day may be used in act 601 with a rule on minimum gap between shifts, to select the valid value for the variable start.

After act 601, computer 1000 performs act 602 wherein another variable endMax is set to maximum possible end of a valid path which begins at start. The maximum possible end may be determined, for example, based on union rules on maximum duration of work without break, and/or hours of operation. Note that the specific manner in which acts 601 and 602 are performed may be different, depending on the embodiment. After performing act 602, computer 1000 enters a second loop in act 603, for each value of a variable end ranging from start+slotDuration to endMax. The variable end can be any time slot during a day, and so there are N=96 possible values for end (as there are N=96 time slots in a day). After performing act 603, computer 1000 enters a third loop in act 604, for each value of a variable nbTransition ranging from 0 to MaxTransition-1. MaxTransition is an upper bound in a range of values for a sequence attribute (e.g. A values), specified via user interface 141 (FIG. 1A). Typically, the value of MaxTransition may be, for example, 4 or 5.

After performing act 604, computer 1000 goes to act 605, to retrieve from matrix 1501, an identifier of a path between start and end which is currently optimal. Note that matrix 1501 for each employee I is three dimensional in some embodiments as illustrated in FIG. 1A, with start and end being two dimensions, and nbTransition as the third dimension. Accordingly, matrix 1501 of some embodiments is of size N×N×A (e.g. 96×96×5) for each employee I, wherein N is the number of time slots in a day and A is the number of values of the sequence attribute (e.g. A=Max Transition). Initially, matrix 1501 is empty, and therefore no sequence is obtained when it is looked up as Matrix[start][end][nbTransition] and hence its last activity a is null.

Therefore, in performing act 609 (as described below) for the first time in each cell of matrix 1501, path may be set to be new activity a′ (e.g. Matrix[start][end][nbTransition] is initialized to activity a′ with nbTransition is set to value 0 and end is set to start+duration of activity a′). Initially, when Matrix[start][end][nbTransition] is empty, act 609 is performed for all possible activities (for employee I), because each activity a at this stage will be found to be different from the last activity (which is the null activity). As will be readily apparent to the skilled artisan in view of this description, there is no restriction, as to which activity a′ may be used to extend a null activity, in initially performing act 609.

Specifically, in some embodiments of act 605, computer 1000 initializes variable CurrentOptimalPath to Matrix[start][end][nbTransition]. Thereafter, computer 1000 goes to act 606, to retrieve from the variable CurrentOptimalPath the activity a. In some embodiments of act 606, activity a=last activity in CurrentOptimalPath. Subsequently, computer 1000 goes to act 607, to enter a fourth loop on each possible activity a′ which is different from activity a. Thereafter, computer 1000 goes to act 608, to enter a fifth loop on each possible duration of activity a′. In act 608, as each possible duration is considered, act 607 may exclude an activity that is same as the last activity a.

Subsequently, computer 1000 goes to act 609, to generate an extended path (i.e. a new sequence), by adding activity a′ after the last activity a in CurrentOptimalPath to obtain ExtendedPath. Then, computer 1000 goes to act 610, to check whether the cost of the newly-generated ExtendedPath is less than the cost of a previously-generated path in matrix 1501 which has the same attribute value. In some embodiments, of act 610, computer 1000 compares cost of ExtendedPath to cost of Matrix[start][ExtendedPathend][nbTransition+1]. If the answer in act 610 is no, then computer 1000 returns to the inner-most of the above-described five loops which is not yet completed. If the answer in act 610 is yes, then computer 1000 goes to act 611 to update matrix 1501 with ExtendedPath and then returns to the inner-most of the above-described five loops which is not yet completed.

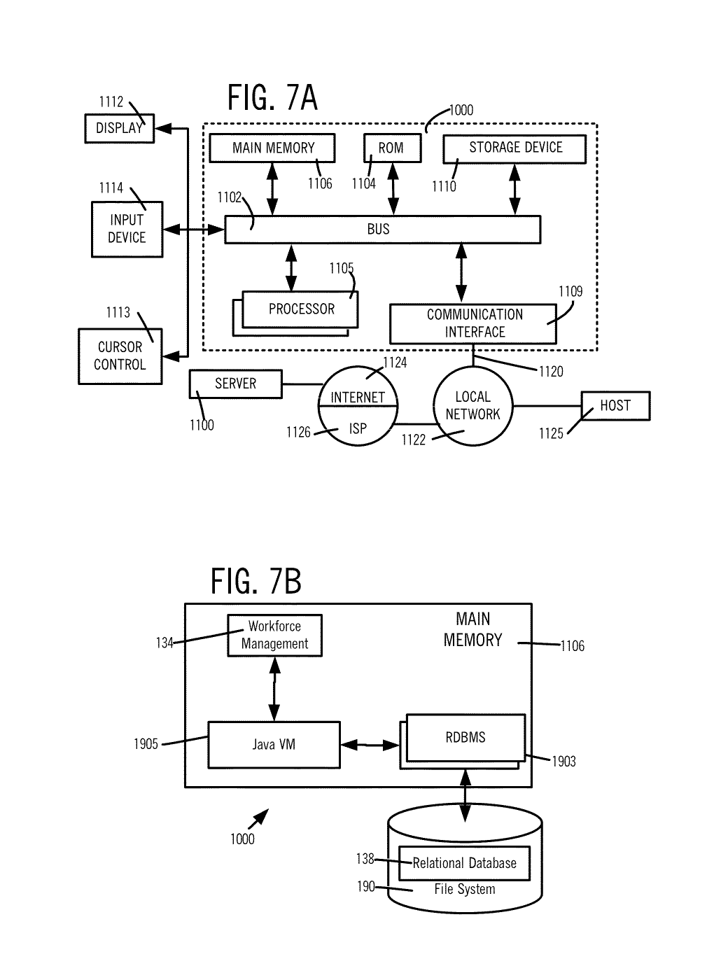

Several embodiments of the type described above are used by computer 1000 to solve a problem of building optimal weekly schedules for multiple employees belonging to the same organization, e.g. in workforce management software 134. One example of such software 134 (FIG. 7B) is commercially available as Oracle Workforce Scheduling, from Oracle Corporation, Redwood Shores, Calif. In some embodiments, one of the inputs to workforce management software 134 is the employees with their skills, their availabilities, and their rules (called also constraints) 113 (FIG. 1A), and another of the inputs is activities of work to be done in the organization with their respective demands, which compose workload 112 (FIG. 1A). Accordingly, workforce management software 134 (FIG. 7B) includes the above-described optimal sequence populator 110 (FIG. 1A).

Such a computer 1000 may be programmed in some embodiments to generate a schedule 171 (FIG. 1A) that matches as best as possible the contribution of employees with the workload while satisfying multiple constraints based on from employee contracts and trade union rules, and satisfying also various business constraints. A schedule 171 provided as a result by computer 1000 of some embodiments is a detailed weekly schedule; detailed on the activities with a 15 minutes time step (also called time slot). That means schedule 171 shows, for each 15 minutes slot of a week, which activity every employee is scheduled to perform. Therefore, schedule 171 gives the time slots in which work is to be done, the time slots for the employee to take a break from work, and the details of activities to be done within time slots of work

In some embodiments, computer 1000 implements column generation based on Dantzig-Wolfe decomposition, which decomposes the set of constraints in two subsets. The overarching idea is that many linear programs are too large to consider all the variables explicitly. Since most of the variables are non-basic and assume a value of zero in the optimal solution, only a subset of variables need to be considered when solving the employee scheduling problem. The column generation approach used in computer 1000 of some embodiments initializes a linear program (LP) with a subset of columns. The method consists then to generate, within an iterative algorithm, the variables which have the potential to improve the objective function, i.e. to find variables with negative reduced cost (assuming without loss of generality that the problem is a minimization problem). These variables are added to populate a linear program. The name “column generation” is used in computer 1000 of certain embodiments wherein a variable represents a column of the LP.

A column generation process used in computer 1000 of some embodiments decomposes the employee scheduling problem being solved into two problems: a master problem and one or more slave problems. Thus, in computer 1000 of several embodiments, a master problem is an original problem of employee scheduling with only a subset of variables being considered (and hence a subset of constraints). The slave problem in computer 1000 of several embodiments is a new problem created to identify new improving variables to be added to the master problem. The objective function of the slave problem in computer 1000 of certain embodiments is reduced cost of the new variable with respect to the current values of the dual variables. The constraints of an initial model of employee scheduling in computer 1000 of some embodiments that are not part of the master problem are respected in the slave problem. The column generation process used in computer 1000 terminates when no negative reduced cost variable can be generated by the slave problem. Accordingly, computer 1000 of several embodiments relies on the fact that the linear program (LP) obtained at the end is smaller than the initial linear program (LP) of the problem with all its variables being explicitly generated.

In modeling the employee scheduling problem, computer 1000 of certain embodiments associates a binary variable with every possible daily schedule of an employee (denoted by Scheduleₑ). Hence, the columns of the linear program modeling in computer 1000 of some embodiments are the daily schedules. Since the number of such schedules is huge, the use of column generation is appropriate in order to generate only the good ones (also called optimal sequences), to be kept in the final linear program. In other words, the employee scheduling problem is decomposed by computer 1000 of certain embodiments into a single master problem and several slave problems. Each slave problem is located by computer 1000 of certain embodiments in a window (one employee, one day) and contains only the constraints of that employee on that day.

The master problem in a computer 1000 of several embodiments contains the weekly constraints, the workload constraints (over several employees) and a main objective function (to be minimized). All the constraints of the master problem in computer 1000 of some embodiments are linear. The column generation process in computer 1000 of several embodiments maintains a permanent communication between a window of the master problem and windows of the slave problems.

The master problem is solved in some embodiments of computer 1000 by use of a simplex algorithm which gives as a result the optimal dual values: kind of indicators given to the slaves to guide their self-optimization on the local window (person, day). An illustrative implementation of the simplex algorithm by computer 1000 may invoke a linear solver known as ILOG CPLEX, available from IBM Corporation.

Thus, computer 1000 of several embodiments provides new schedules to its master window, corresponding to a local window (person, day) of the slave, with each new schedule having the potential to decrease the value of the objective function. The master linear program (LP) formulated by computer 1000 of some embodiments initially contains no schedule, hence no column. A schedule 171 (FIG. 1A) is iteratively populated by day schedules built by local windows of slave problems until no negative reduced cost schedule can be generated.

When the column generation algorithm is finished, employee scheduling problem is not solved in computer 1000 of several embodiments, since we have got an optimal continuous solution and not a mixed integer one. A final step consists in computer 1000 of several embodiments launching a MIP solver on the final master LP in order to select the optimal schedules (those corresponding to the variables Schedule, with a value 1 in the solution).

The method of FIG. 1B or FIG. 6 may be used to program one or more computer(s) 1000, each of which may be implemented as illustrated in FIG. 7A which is discussed next. Specifically, computer 1000 includes a bus 1102 (FIG. 7A) or other communication mechanism for communicating information, and one or more processor(s) 1105 coupled with bus 1102 for processing information. Computer 1000 uses (as the above-described memory) a main memory 1106, such as a random access memory (RAM) or other dynamic storage device, coupled to bus 1102 for storing information and instructions (e.g. to perform the acts of FIG. 1B) to be executed by processor 1105.

Main memory 1106 also may be used for storing temporary variables or other intermediate information during execution of instructions to be executed by processor 1105. Computer 1000 further includes a read only memory (ROM) 1104 or other static storage device coupled to bus 1102 for storing static information and instructions for processor 1105, such as software in the form of model generator 440. A storage device 1110, such as a magnetic disk or optical disk, is provided and coupled to bus 1102 for storing information and instructions.

Computer 1000 may be coupled via bus 1102 to a display device or video monitor 1112 such as a cathode ray tube (CRT) or a liquid crystal display (LCD), for displaying information to a computer user (e.g. a store manager) may be displayed on display 1112. An input device 1114, including alphanumeric and other keys (e.g. of a keyboard), is coupled to bus 1102 for communicating information (such as user input) to processor 1105 (e.g. executing user interface 143 of FIG. 1A). Another type of user input device is cursor control 1116, such as a mouse, a trackball, or cursor direction keys for communicating information and command selections to processor 1105 and for controlling cursor movement on display 1112. This input device typically has two degrees of freedom in two axes, a first axis (e.g., x) and a second axis (e.g., y), that allows the device to specify positions in a plane. In addition to display device 1112, computer 1000 may include a speaker (not shown) as another output device for use by processor 1105 (e.g. executing user interface 443 of FIG. 1A).

As described elsewhere herein, workforce management is implemented by computer 1000 in response to processor 1105 executing one or more sequences of one or more instructions that are contained in main memory 1106. Such instructions may be read into main memory 1106 from another non-transitory computer-readable storage medium, such as storage device 1110. Execution of the sequences of instructions contained in main memory 1106 causes processor 1105 to perform the operations of a process described herein and illustrated in FIG. 1B. In alternative embodiments, hard-wired circuitry may be used in place of or in combination with software instructions.

The term “non-transitory computer-readable storage medium” as used herein refers to any non-transitory storage medium that participates in providing instructions to processor 1105 for execution. Such a non-transitory storage medium may take many forms, including but not limited to (1) non-volatile storage media, and (2) volatile storage media. Common forms of non-volatile storage media include, for example, a floppy disk, a flexible disk, hard disk, optical disk, magnetic disk, magnetic tape, or any other magnetic medium, a CD-ROM, any other optical medium, punch cards, paper tape, any other physical medium with patterns of holes, a PROM, and EPROM, a FLASH-EPROM, any other memory chip or cartridge that can be used as storage device 1110, to store program code in the form of instructions and/or data structures and that can be accessed by computer 1000. Volatile storage media includes dynamic memory, such as main memory 1106 which may be implemented in the form of a random access memory or RAM.

Instructions to processor 1105 can be provided by a transmission link or by a non-transitory storage medium from which a computer can read information, such as data and/or code. Specifically, various forms of transmission link and/or non-transitory storage medium may be involved in providing one or more sequences of one or more instructions to processor 1105 for execution. For example, the instructions may initially be comprised in a non-transitory storage device, such as a magnetic disk, of a remote computer. The remote computer can load the instructions into its dynamic memory (RAM) and send the instructions over a telephone line using a modem.

A modem local to computer 1000 can receive information about a change to a collaboration object on the telephone line and use an infra-red transmitter to transmit the information in an infra-red signal. An infra-red detector can receive the information carried in the infra-red signal and appropriate circuitry can place the information on bus 1102. Bus 1102 carries the information to main memory 1106, from which processor 1105 retrieves and executes the instructions. The instructions received by main memory 1106 may optionally be stored on storage device 1110 either before or after execution by processor 1105.

Computer 1000 also includes a communication interface 1115 coupled to bus 1102. Communication interface 1115 provides a two-way data communication coupling to a network link 1120 that is connected to a local network 1122. Local network 1122 may interconnect multiple computers (as described above). For example, communication interface 1115 may be an integrated services digital network (ISDN) card or a modem to provide a data communication connection to a corresponding type of telephone line. As another example, communication interface 1115 may be a local area network (LAN) card to provide a data communication connection to a compatible LAN. Wireless links may also be implemented. In any such implementation, communication interface 1115 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1125 or to data equipment operated by an Internet Service Provider (ISP) 1126. ISP 1126 in turn provides data communication services through the world wide packet data communication network 1124 now commonly referred to as the “Internet”. Local network 1122 and network 1124 both use electrical, electromagnetic or optical signals that carry digital data streams. The signals through the various networks and the signals on network link 1120 and through communication interface 1115, which carry the digital data to and from computer 1000, are exemplary forms of carrier waves transporting the information.

Computer 1000 can send messages and receive data, including program code, through the network(s), network link 1120 and communication interface 1115. In the Internet example, a server 1100 might transmit information retrieved from RDBMS database through Internet 1124, ISP 1126, local network 1122 and communication interface 1115. The instructions for performing the operations of FIG. 1B may be executed by processor 1105 as they are received, and/or stored in storage device 1110, or other non-volatile storage for later execution. In this manner, computer 300 may additionally or alternatively obtain instructions and any related data in the form of a carrier wave.

Note that FIG. 7A is a very low-level representation of many hardware components of a computer system. Several embodiments have one or more additional software components in main memory 1106 as shown in FIG. 7B. In addition to main memory 1106, computer 1000 may include one or more other types of memory such as flash memory (or SD card) and/or a hard disk and/or an optical disk (also called “secondary memory”) to store data and/or software for loading into memory 1106 (also called “main memory”) and/or for use by processor(s) 1105. In some embodiments, computer 1000 of FIG. 7A implements a relational database management system 1905 to manage data in one or more tables of a relational database 1903 of the type illustrated in FIG. 7B. Such a relational database management system 1903 may manage a distributed database system that includes multiple databases, each table being stored on different storage mechanisms.

In some embodiments, the multiple databases are made to appear as a single database. In such embodiments, processor 1105 can access and modify the data in a relational database 138 via RDBMS 1903 that accepts queries in conformance with a relational database language, the most common of which is the Structured Query Language (SQL). The commands are used by processor 1105 of some embodiments to store, modify and retrieve data about an application program in the form of rows in a table in relational database 138. Relational database management system 1903 further includes output logic that makes the data in a database table available to a user via a graphical user interface that generates a screen on a video monitor display 1112. In one example, the output logic of computer 1000 provides results via a web-based user interface that depicts in a browser, information related to schedules of activity assignments as illustrated in FIG. 1A. Additionally and/or alternatively, screens responsive to a command in a command-line interface and display on a video monitor may be generated in a user interface 141 (such as a GUI of the type described above in reference to FIG. 1A).

In some embodiments of computer 1000, functionality in the above-described optimal sequence populator 110 is implemented by processor 1105 executing software in memory 1106 of computer 1000, although in other embodiments such functionality is implemented in any combination of hardware circuitry and/or firmware and/or software in computer 1000. Depending on the embodiment, various functions of the type described herein may be implemented in software (executed by one or more processors or processor cores) or in dedicated hardware circuitry or in firmware, or in any combination thereof. Accordingly, depending on the embodiment, any one or more of optimal sequence populator 110 can, but need not necessarily include, one or more microprocessors, embedded processors, controllers, application specific integrated circuits (ASICs), digital signal processors (DSPs), multi-core processors and the like.

Any non-transitory computer readable medium tangibly embodying software (also called “computer instructions”) may be used in implementing one or more acts described herein and illustrated in FIG. 1B. Such software may include program codes stored in memory 1106 and executed by processor 1105. Memory 1106 may be implemented within or external to processor 1105, depending on the embodiment. When implemented in firmware and/or software, logic to perform one or more acts of FIG. 1B may be stored as one or more computer instructions or code on a non-transitory computer-readable medium. Examples include non-transitory computer-readable storage media encoded with a data structure such as a matrix 1501 that holds optimal sequences (FIG. 1A) and non-transitory computer-readable storage media encoded with a computer program to implement optimal sequence populator 110.

In some embodiments, a computer 1000 may include multiple processors, each of which is programmed with software in a memory 1106 shared with each other to perform acts of the type described above to maintain optimal sequences in a matrix 1501, for multiple values (A values) of a sequence attribute in a predetermined range, for numerous periods (N periods) of time in a day. For example, a first processor 1105 in computer 1000 may be programmed with software to implement means for generating a new sequence comprising new assignments of activities in an organization to be performed in a specific period of time, the new sequence having an attribute, the attribute having a value determined by the new assignments comprised in the new sequence. A second processor 1105 in computer 1000 may be programmed with software to implement means, responsive to the value of the attribute, for identifying an existing sequence comprising existing assignments of the activities, to be performed in the specific period of time. A third processor 1105 in computer 1000 may be programmed with software to implement means, responsive to comparison of a new cost of the new sequence and an existing cost of the existing sequence, for selecting one of the new sequence and the existing sequence as an optimal sequence having the attribute of the value, wherein the optimal sequence is to be performed in the specific period of time. A fourth processor 1105 in computer 1000 may be programmed with software to implement means for storing in a computer memory, a result output by the means for selecting.

Although four processors 1105 have been just described for some embodiments to implement the respective means for generating, means for identifying, means for selecting, and means for storing, in other embodiments a single processor 1105 may be used in a time shared manner to implement the just-described four means. Furthermore, in still other embodiments, one processor 1105 may be used in a time-shared manner to implement one or more parts of the means for generating, one or more parts of the means for identifying, one or more parts of the means for selecting and one or more parts of the means for storing. Moreover, one or more other processors 1105 may be also used in a time-shared manner to implement other parts of the means for generating, other parts of the means for identifying, other parts of the means for selecting and other parts of the means for storing. Furthermore, although processors 1105 have been described above for certain embodiments as being included in a single computer 1000, in other embodiments multiple such processors 1105 may be included in multiple computers 1000, for example a first computer 1000 may implement the means for generating while a second computer 1000 may implement the means for selecting.

In one or more such embodiments, one or more processor(s) 1105 with a bus 1103 implement means for storing in memory 1106, the outputs generated by the means for generating and the means for selecting, in the form of one or more lists, each list identifying a sequence of assignments of activities of work to be performed in an organization. One or more such processors 1105 may also implement other functionality, such as schedule generator 160 that generates employee schedules 171 (FIG. 1A). One or more such processors 1105 may further implement additional functionality in optimal sequence populator 110, such as a user interface 141 that generates screens on display 1112 through which a user may view (and use a keyboard and/or mouse to edit) data in memory 1106, such as time slots on a working day 111, workload (activities) 112, employees and skills 113, employee schedules 171, and optimal sequences in matrix 1501. The optimal sequences in matrix 1501 may be stored in a database 138 (FIG. 7B) which may additionally store employee schedules indicative of each time slot in a day (e.g. identified by start time & duration) and a specific activity which is to be performed by a specific employee in a specific time slot.

Numerous modifications and adaptations of the embodiments described herein will become apparent to the skilled artisan in view of this disclosure. Numerous modifications and adaptations of the embodiments described herein are encompassed by the attached claims.

1. A computer-implemented method to allocate activities to employees in an organization, the computer-implemented method comprising:
generating a new sequence comprising first assignments of activities of work to be performed by an employee in the organization, the new sequence having an attribute, the attribute having a specific value determined by the first assignments comprised in the new sequence;
wherein the new sequence is to be performed in a particular period of time of a day;
using at least the specific value of the attribute of the new sequence and the particular period of time to identify a stored sequence comprising second assignments of the activities of work to be performed by the employee;
comparing at least a new cost of the new sequence and an old cost of the stored sequence, to determine optimality; and
storing the new sequence in a memory of a computer, when the new sequence is determined to be more optimal than the stored sequence;
wherein at least the generating, the using, and the comparing are performed multiple times, by one or more processors coupled to the memory.

2. The method of claim 1 wherein:
the attribute is a number of transitions between assignments of activities in each sequence.

3. The method of claim 2 wherein:
the number of transitions is one less than a number of assignments of activities.

4. The method of claim 1 wherein:
the attribute is a number of assignments of activities in each sequence.

5. The method of claim 1 wherein:
the specific value of the attribute is used as an index into a matrix, to look up the stored sequence.

6. The method of claim 5 wherein:
the index is hereinafter a first index;
an identification of the new sequence is stored in the matrix; and
a starting time of the specific period of time is a second index into the matrix.

7. The method of claim 6 wherein:
the matrix is three dimensional; and
an ending time of the specific period of time is a third index into the matrix.

8. The method of claim 1 wherein:
the specific period of time does not include any break, rest or lunch period.

9. The method of claim 1 wherein:
the new sequence comprises a smaller sequence; and
the new sequence is generated by concatenating a new assignment to a last assignment in the smaller sequence.

10. The method of claim 1 further comprising:
generating additional new sequences of assignments of activities scheduled for performance in the specific period of time in the day respectively having additional new values of the attribute;
using the additional new values of the attribute to identify additional stored sequences; and
for the additional new values of the attribute, comparing new costs of the additional new sequences and old costs of the additional stored sequences to determine optimality therebetween.

11. The method of claim 1 wherein:
during the storing, the new sequence replaces the stored sequence.

12. One or more non-transitory computer-readable storage media comprising a plurality of instructions executable by a computer, the plurality of instructions comprising:
instructions to generate a new sequence comprising first assignments of activities of work to be performed by an employee in the organization, the new sequence having an attribute, the attribute having a specific value determined by the first assignments comprised in the new sequence;
wherein the new sequence is to be performed in a particular period of time of a day;
instructions to use at least the specific value of the attribute and the particular period of time, to identify a stored sequence comprising second assignments of the activities of work to be performed by the employee;
instructions to compare, for the specific value of the attribute and for the particular period of time, at least a first cost of the new sequence and a second cost of the stored sequence, to determine optimality;
instructions to store the new sequence in a memory of a computer, when the new sequence is determined to be more optimal than the stored sequence; and
instructions to cause execution of at least the instructions to generate, the instructions to use, and the instructions to compare, multiple times by one or more processors coupled to the memory.

13. The one or more non-transitory computer-readable storage media of claim 12 wherein:
the attribute is a number of transitions between assignments of activities in each sequence.

14. The one or more non-transitory computer-readable storage media of claim 13 wherein:
the number of transitions is one less than a number of assignments of activities.

15. The one or more non-transitory computer-readable storage media of claim 12 wherein:
the attribute is a number of assignments of activities in each sequence.

16. The one or more non-transitory computer-readable storage media of claim 12 wherein:
the instructions to identify comprise instructions to use the value of the attribute as an index into a matrix, to look up the stored sequence.

17. The one or more non-transitory computer-readable storage media of claim 16 wherein the index is hereinafter a first index, and wherein:
an identification of the new sequence is stored in the matrix; and
a starting time of the specific period of time is a second index into the matrix.

18. The one or more non-transitory computer-readable storage media of claim 17 wherein the matrix is three dimensional, and wherein:
an ending time of the specific period of time is a third index into the matrix.

19. The one or more non-transitory computer-readable storage media of claim 12 wherein:
the new sequence comprises a smaller sequence; and
the new sequence is generated by concatenating a new assignment to a last assignment in the smaller sequence.

20. An apparatus comprising at least one processor coupled to at least one memory, the apparatus comprising:
means for generating a new sequence comprising first assignments of activities of work to be performed by an employee in the organization, the new sequence having an attribute, the attribute having a specific value determined by the first assignments comprised in the new sequence;
wherein the new sequence is to be performed in a particular period of time of a day;
means for using at least the specific value of the attribute of the new sequence and the particular period of time to identify a stored sequence comprising second assignments of the activities of work to be performed by the employee;
means for comparing, for the specific value of the attribute and for the particular period of time, at least a first cost of the new sequence and a second cost of the stored sequence to determine optimality;
means for storing the new sequence in a memory of a computer, when the new sequence is determined to be more optimal than the stored sequence; and
means for operating at least the means for generating, the means for using and the means for comparing multiple times.
